(19) United States
(12) Patent Application Publication
(10) Pub. No.: US 2020/0098074 A1
(43) Pub. Date: Mar. 26, 2020

(54) Continuing Education Management System

(71) Applicant: Chantel M. Moore, Bolingbrook, IL (US)

(72) Inventor: Chantel M. Moore, Bolingbrook, IL (US)

(21) Appl. No.: 16/414,173

(22) Filed: May 16, 2019

Related U.S. Application Data
(60) Provisional application No. 62/672,818, filed on May 17, 2018.

(51) Int. Cl. G06Q 50/20; G06F 16/9032

(52) U.S. Cl. CPC G06Q 50/2057; G06F 16/90328

(57) ABSTRACT

This invention is a system for managing continuing education that is usable by physicians and other licensed professionals, providers, and reviewers.

### BACKGROUND

The present disclosure is generally directed to systems for managing continuing education credits.

Physicians and other licensed professionals, including, but not limited to, nurses, pharmacists, dentists, and optometrists are typically required to obtain continuing education credits annually or semi-annually. Such credits are obtained by attending lectures, watching recorded videos, joining webinars, or participating in other educational activities. Physicians must keep track of how many credits they earn for each activity, as well as how many total credits they have earned in a certain time period. Physicians must spend time locating continuing education activities that they are interested in, and registering for these activities. Physicians must keep records certifying that they have completed they activities they are claiming credit for, and must report their credits to various agencies, such as employers, state medical boards, and medical specialty boards.

Some systems currently exist to simplify and automate some of the tasks associated with managing continuing education credits, such as the system described in U.S. patent publication No. 2007/0078225. Such a system enables users to list, search, and register for continuing education courses and track courses completed; and allows providers to add courses and certify completion. Such a system lacks some key features that would simplify the process of managing continuing education credits and save physicians a great deal of time, such as providing a single interface for all communications and requests for information between a physician and a continuing education provider, real-time certification when a physician completes a continuing education activity, and management of follow-on actions.

It would be useful to have a reliable, convenient, complete, easy-to-use method or device for solving the above-mentioned issues related to managing continuing education.

### SUMMARY

In one example of a continuing education management system according to this invention, computer-readable instructions run on a smart-phone or other mobile computing device and provide a user interface with the following components: dashboard, search, credits, transcripts, activity, settings, and messages. The dashboard component is displayed when a user logs into the system, and displays the following information: the time period that the credits are earned for, earned continuing education credits, and the number of credits that need to be completed. The search component enables a user to search for continuing education activities using a combination of one or more of the following filters: city, state, distance from city or state, specialty, grand rounds, organization, quantity of credits, courses that do or do not include prework, and courses that do or do not include post-work. The transcripts component lists completed continuing education activities and credits earned, and includes the following information: name, id number, continuing education activity name, number of credits earned for each activity, total number of credits earned. The credits component lists all the continuing education credits the user has completed and the credits that need to be completed. The activity component lists the continuing education activities that a user has registered for, enrolled in, or completed, along with the following information for each activity: status, credits, provider contact information, description, activity address, activity pre-work, activity post-work. The settings component allows a user to enter profile information, including the following: name, street address, city, state, phone number, e-mail address, employer name, employer street address, employer city, employer state, employer zip code, specialty board, specialty board street address, specialty board city, specialty board state, specialty board zip code. The settings component also allows a user to control whether notifications are sent by text message or e-mail. The messages component allows a user to send and receive messages from providers of continuing education activities, medical specialty boards, state medical societies, employers, volunteer organizations, and other involved parties.

In another example of a continuing education management system according to this invention, computer-readable instructions run on a smart-phone or other mobile computing device and provide a provider interface with the following components: dashboard, activity management, attendees. The provider dashboard component includes a welcome message, the number of continuing education activities occurring, the number of attendees registered for each continuing education activity, the number waitlisted for each activity, and a space to create a new activity. The activity management component includes links for draft, past, and future activities, as well as an interface for creating a new activity; selecting a link enables a provider to see more information for specific activities or participants. The attendees component enables a provider to enroll participants in continuing education activities by automatically enrolling all registrants or by manually confirming each registrant.

In another example of a continuing education management system according to this invention, computer-readable instructions run on a smart-phone or other mobile computing device and provide a reviewer with the following components: dashboard, search, roster. The reviewer dashboard component includes a welcome message, statistics, and messages. The search component enables a reviewer to search for a user by first name or last name. The roster component enables a reviewer to review users who have completed their continuing education courses for each cohort, users who have not, users who have a few continuing education credits done, and to see user's transcripts.

These as well as other aspects, advantages, and alternatives, will become apparent to those of ordinary skill in the art by reading the following detailed description, with reference where appropriate to the accompanying drawings.

### BRIEF DESCRIPTION OF THE DRAWINGS

FIG. 1 is a layout diagram illustrating the user dashboard component of an example embodiment.

FIG. 2 is a layout diagram illustrating the user search component of an example embodiment.

FIG. 3 is a layout diagram illustrating the user credits component of an example embodiment.

FIG. 4 is a layout diagram illustrating the user transcripts component of an example embodiment.

FIG. 5 is a layout diagram illustrating the user activity management component of an example embodiment.

FIG. 6 is a layout diagram illustrating the user settings component of an example embodiment.

FIG. 7 is a layout diagram illustrating the user messages component of an example embodiment.

FIG. 8 is a layout diagram illustrating the provider dashboard component of an example embodiment.

FIG. 9 is a layout diagram illustrating the provider activity management component of an example embodiment.

FIG. 10 is a layout diagram illustrating the provider attendee management component of an example embodiment.

FIG. 11 is a layout diagram illustrating the provider messages component of an example embodiment.

FIG. 12 is a layout diagram illustrating the reviewer dashboard component of an example embodiment.

FIG. 13 is a layout diagram illustrating the reviewer search and reviewer roster components of an example embodiment.

FIG. 14 is a usage scenario diagram illustrating a typical use case of an example embodiment.

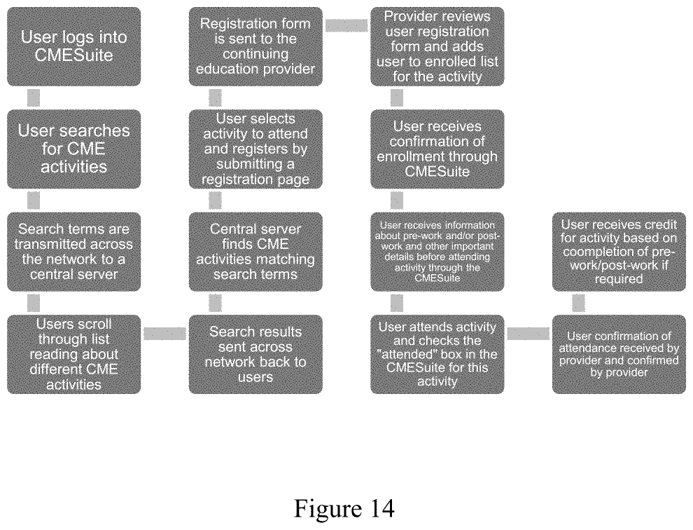

### DETAILED DESCRIPTION

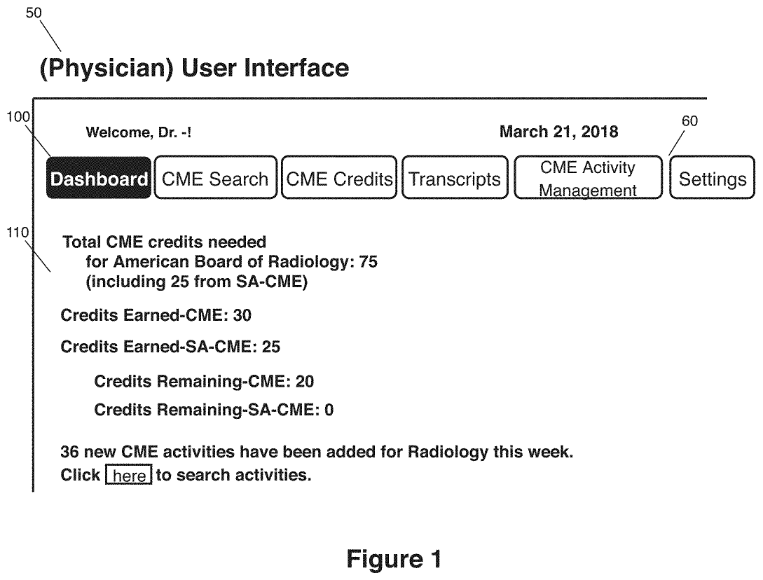

In the example embodiment illustrated in FIG. 1, a continuing education management interface for users 50 provides links 60 to the following components: dashboard 100, search 200, credits 300, transcripts 400, activity 500, settings 600. The dashboard 100 component is displayed when a user logs into the system, and displays the following dashboard information 110: the time period that the credits are earned for, earned continuing education credits, and the number of credits that need to be completed.

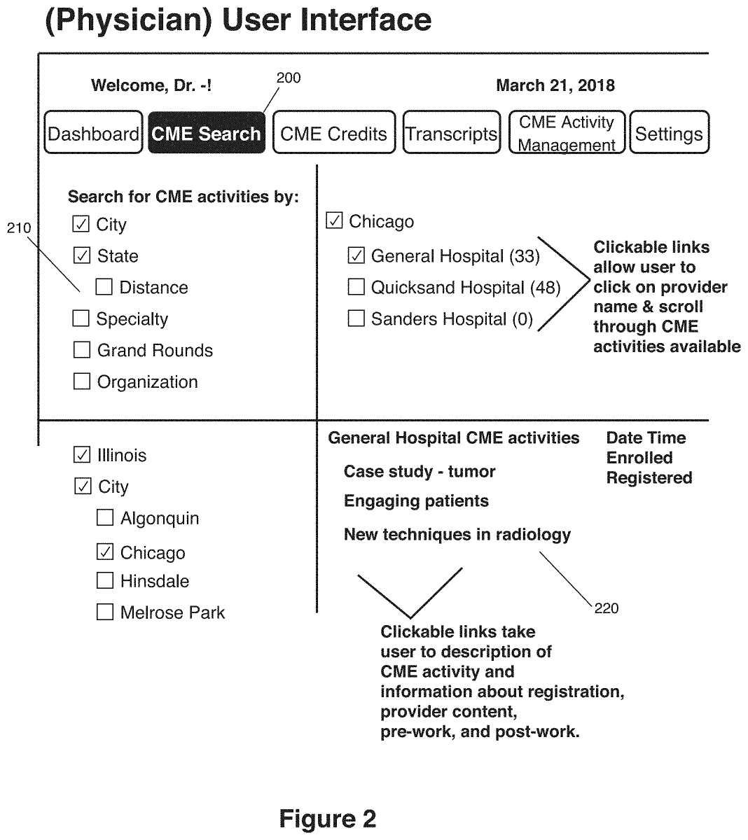

As illustrated in FIG. 2, the search 200 component enables a user to search for continuing education activities using a combination of one or more of the following filters 210: city, state, distance from city or state, specialty, grand rounds, organization, quantity of credits, courses that do or do not include pre-work, and courses that do or do not include post-work. Users can also search by conference and search functions will be customized for various health professions. A search by city or state will prompt the user to select from a list of cities or states. The interface 50 will populate the continuing education activities list 220 available in the geographic location selected by the user. The user can also include distance from a city or state in the search. A search by specialty will return a list of physician specialties, such as, gastroenterology, cardiology, etc. A search by Grand Rounds will give the user a list of Grand Rounds continuing education activities available in various cities and states. A search by organization will allow the user to select an organization. A continuing education activities list 220 of all available continuing education activities for that organization will populate for the user.

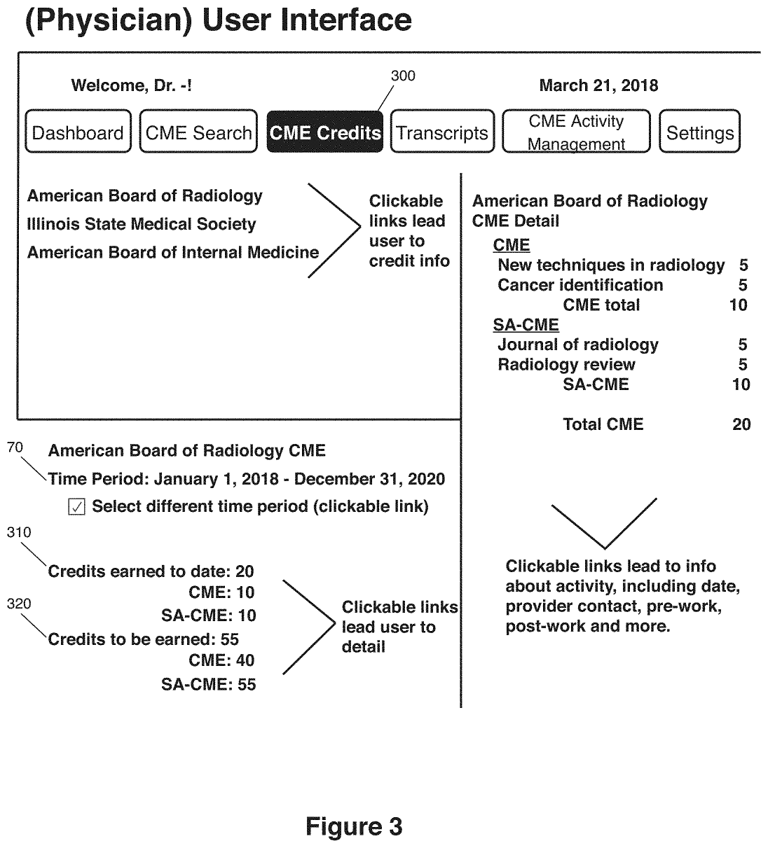

As illustrated in FIG. 3, the credits 300 component lists all the completed continuing education credits 310 for the user and the credits remaining to be completed 320. When users sign up to use the continuing education management system, users will enter the time period 70 that the continuing education will be tracked for.

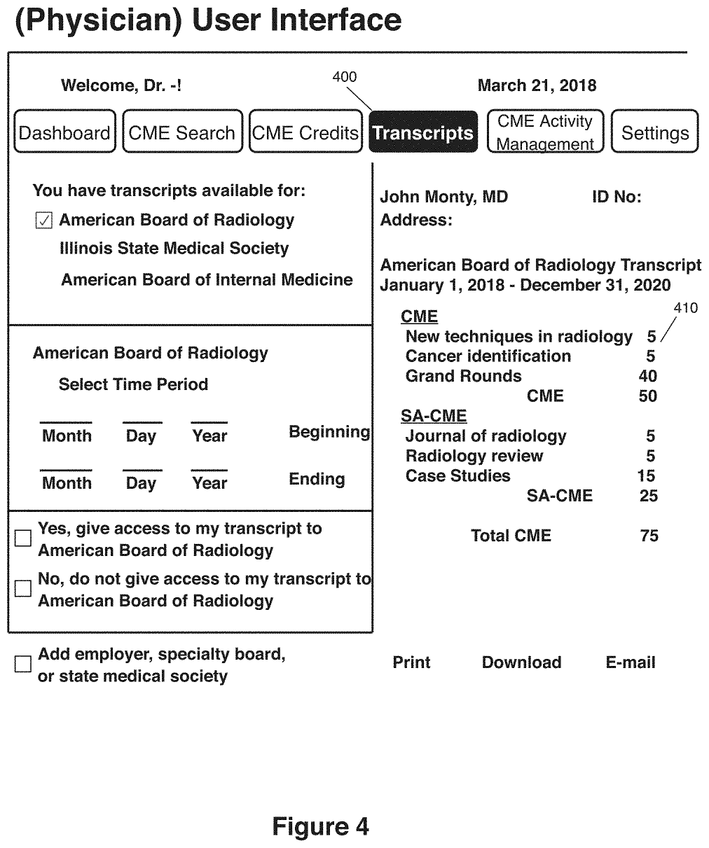

As illustrated in FIG. 4, the transcripts and certificates 400 component lists completed continuing education activities 410 with credits earned. Transcripts and certificates 400 component displays the following information: user name, user id number, provider organization name, continuing education activity name, number of credits earned for each activity, total number of credits earned. Users have the option to create a customized transcript of their completed continuing education courses and credits earned within a specific time frame for various organizations. The system will allow for a total of 10 transcripts per user. Users can give the various organizations access to their transcripts, for the organizations to view in the organization's interface. For example, a user may create a transcript for a specialty board, with a time frame of Jan. 1, 2018 to Dec. 31, 2018, which will include all continuing education credits earned in this time frame. The user will enter their specialty board ID number into the transcript. The user will give access to this transcript, to the specialty board. The specialty board will see the user's transcript in the specialty board's interface. The user may create another transcript for a state medical society with a time frame of Aug. 1, 2019 to Jul. 31, 2024. The user will enter the state medical society ID number into the transcript. The user will give access to this transcript to the state medical society. The state medical society will see this transcript in the state medical society's interface. Users check a box to give access to their transcripts to employers, Specialty Board, or state medical societies. Users may create a maximum of 10 transcripts for various organizations. Users will also receive one certificate of completion, for each CME activity complete. Certificates will be awarded by the CME provider and will include: user name, provider organization name, continuing education activity name, number of credits earned for the activity, total number of credits earned. Users will be able to upload certificates received prior to joining CME Suite and manually add the credits to their transcripts.

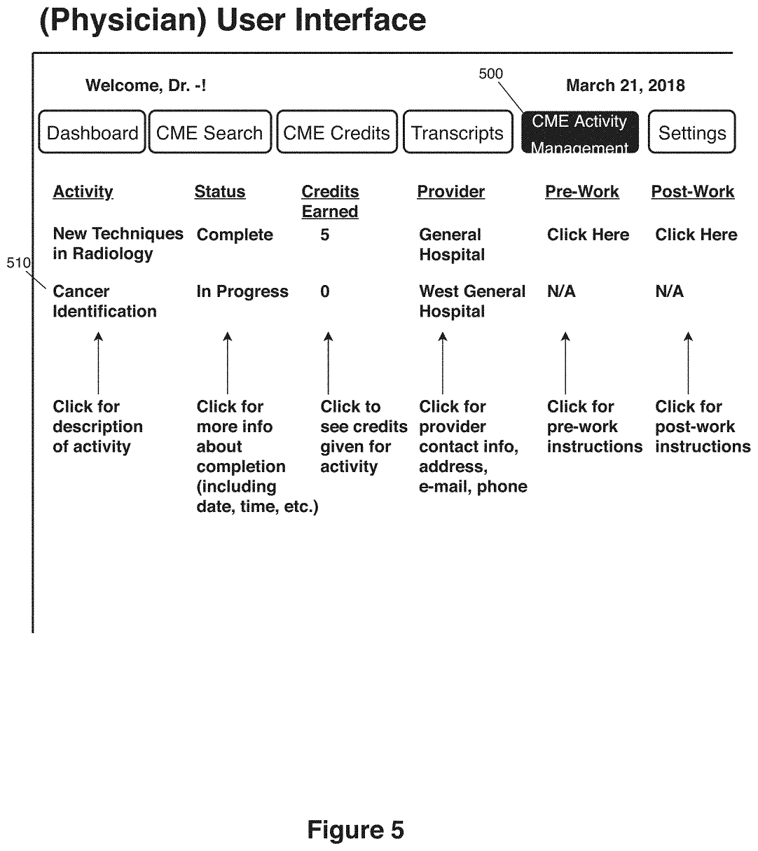

As illustrated in FIG. 5, the activity 500 component lists the active continuing education activities 510. Active continuing education activities 510 are activities that a user has registered for, enrolled in, or completed. The following information is listed for each activity: status (registered, enrolled, waitlisted, in-progress, completed), credits (the number of credits that the user has earned or will earn), provider contact information (e-mail address and phone number), description of the activity, activity address, activity pre-work (if applicable), activity post-work (if applicable).

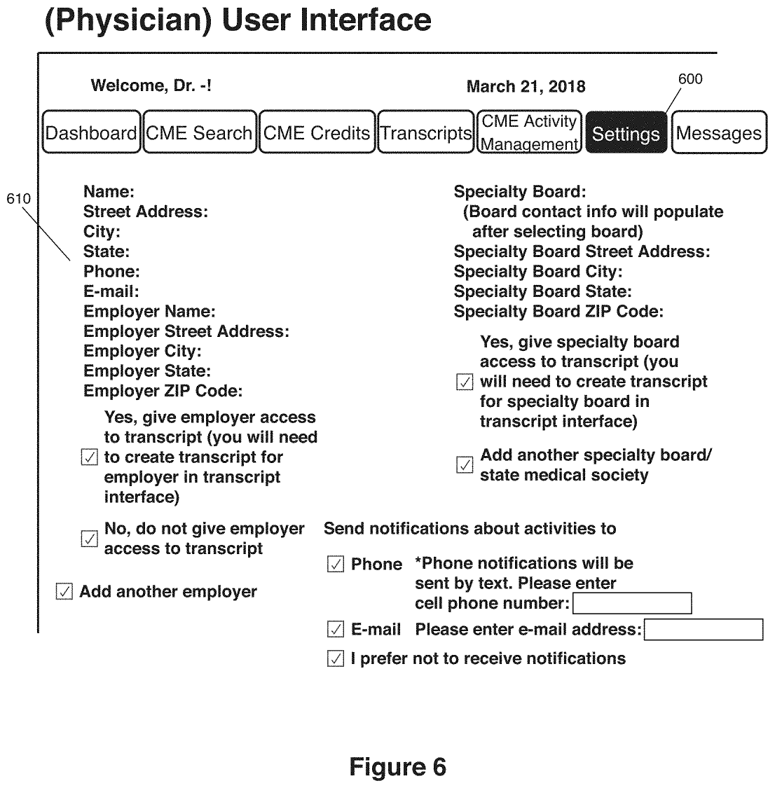

As illustrated in FIG. 6, the settings 600 component allows a user to enter profile information 610. Profile information 610 includes the following: name, street address, city, state, phone number, e-mail address, employer name, employer street address, employer city, employer state, employer zip code, specialty board (Board contact information will populate after selecting Board), specialty board street address, specialty board city, specialty board state, specialty board zip code. The settings 600 component allows a user to control whether notifications are sent by text message or e-mail (or if no notifications are sent). The settings 600 component allows a user to enter the e-mail address or phone number where notifications will be sent.

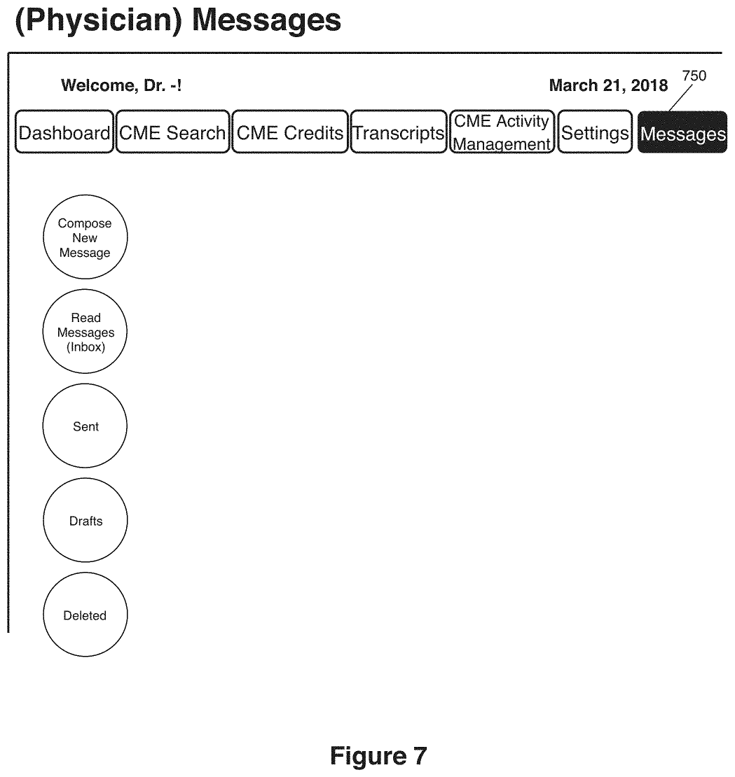

As illustrated in FIG. 7, the messages 750 component allows a user to access and read existing messages, and compose and send new messages. Users will also have the ability to attach documents to the emails.

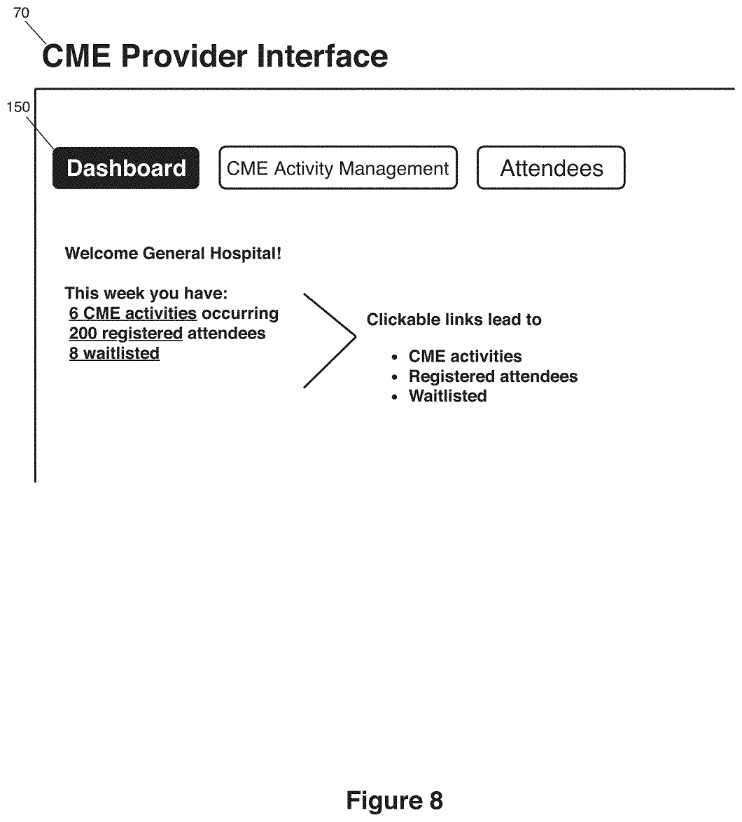

In the example embodiment illustrated in FIG. 8, a continuing education management interface for providers 70 provides the following components: dashboard 150, activity management 250, attendees 350, messages, and data reports. The provider dashboard 150 component displays a welcome message, the number of continuing education activities occurring, the number of attendees registered for each continuing education activity, the number waitlisted for each activity, and a space to create a new activity.

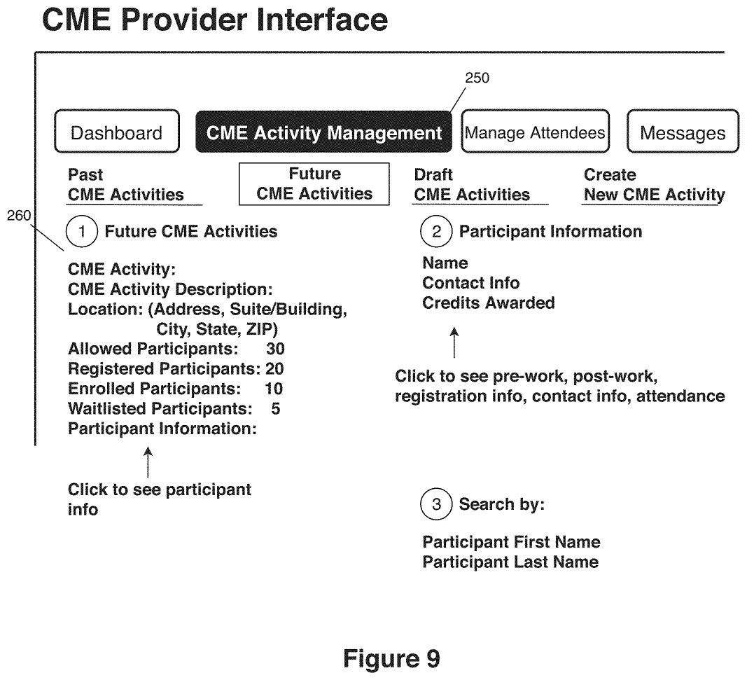

The activity management 250 component illustrated in FIG. 9 includes continuing education activity links 260. Continuing education activity links 260 display information for draft, past, and future activities. Activity management 250 component also includes an interface for creating a new activity. Selecting an activity link enables a provider to see more information for specific activities, including activity data, participant registration information, participant contact information, credits awarded to participants, and search (providers can search for participants by first name, last name). By selecting a participant's name within the activity, a provider may see additional information, including: pre-work, post-work, participant registration information, participant contact information, if the participant attended the course, credits awarded to the participant. Providers can also create new continuing education activities in the activity management component. By clicking the NEW ACTIVITY button, providers will enter the following information: continuing education activity name, continuing education activity description (this will include a description of pre-work/post-work), continuing education activity time (1 pm-2 pm; one hour 3 days a week, etc), continuing education activity credits, provider contact information (individual to contact about questions regarding the activity), continuing education activity street address, continuing education activity city, continuing education activity state, continuing education activity zip code. After entering the activity information, a provider may select the following: DELETE (deletes entered activity information), SAVE AS DRAFT (saves entered activity information), REVIEW (provider must review the activity information before publishing). If the provider chooses to review the activity information, the provider will be taken to another screen where the provider can review the information or edit the information. If the information is correct, then the provider will have the option to PUBLISH the activity information. At this time, the continuing education activity will be available for the users to see and enroll in. If the provider notices that edits are required before publishing the continuing education activity information, the provider can select EDIT and the provider will be taken to the previous screen, where the provider entered the information, to make the edits.

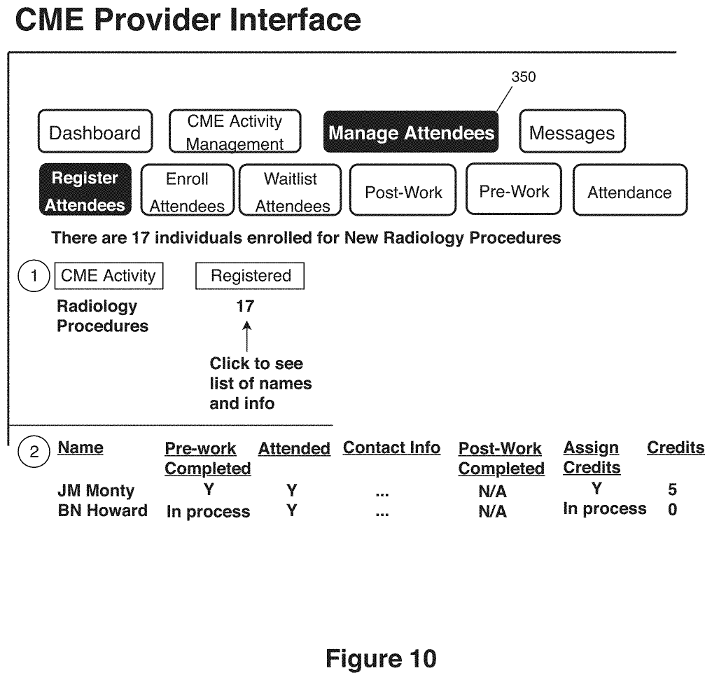

The attendee management 350 component illustrated in FIG. 10 enables a provider to enroll participants in continuing education activities by automatically enrolling all registrants or by manually confirming each registrant. To manually enroll registrants, a provider will log-in to the system and confirm each user registration. After confirming each user's registration, the system will send an enrollment confirmation notification to the user. Providers will have two options to manage the continuing activity when the activity reaches capacity: manually close registration for the activity, or automatically close registration for the activity. If providers choose to manually close the continuing education activity, when the activity is 5 registrants away from capacity the provider will receive a warning notification indicating this. When capacity for the continuing education activity is reached, the provider will receive another notification indicating capacity for the continuing education activity has been reached. At this time, the provider will enter the system and close registration for the continuing education activity. If the provider chooses for the system to close registration when the continuing education activity reaches capacity, the provider will receive a notification when registration is 5 registrants from capacity. The provider will also receive a notification when the activity has reached capacity and the system has closed registration. Providers have two options to manage waitlists for continuing education activities: manually waitlist registrants, or automatically waitlist registrants. If the provider chooses to manually waitlist registrants for the continuing education activity, the provider will receive a notification for each new registrant. Notifications can be turned off. The provider will log-in to the system and manually waitlist each registrant. The system will send confirmation waitlisted notifications to the registrants. If the provider chooses to automatically waitlist registrants for the continuing education activity, then after the continuing education activity reaches capacity, the system will open the waitlist and add registrants to it. The registrants will receive a notification from the system indicating that they have been waitlisted for the continuing education activity. To enroll waitlisted registrants, the system will generate a list of waitlisted registrants for the activity. The provider will manually remove the registrants from the waitlist and enroll them in the activity, if space becomes available. If space does not become available, the provider will send waitlisted registrants a notification that space did not become available.

When users register for a continuing education activity, there is a box to check for special accommodations. If users require special accommodations, a box will populate for users to enter what the accommodations are. The provider will see this box. The system will generate a list of enrolled participants with space for special notes, include dietary needs, if the activity will serve food and special accommodations request. Providers can upload pre-work for users through the system. The system will send a notification to the registrant that there is pre-work to be completed. When the user completes it and uploads it to the system, the pre-work will be available for the provider to view. At any time, notifications for the provider and the activity registrants can be turned off. Providers can upload post-work for users through the system. The system will send a notification to the user that there is post-work to be completed. When the user completes it and uploads it to the system, the post-work will be available for the provider to view. At any time, notifications for the provider and the users can be turned off. During or after attending a continuing education activity, users will log into the system and check a box labeled ‘attended’. At the completion of the activity, the provider will receive a roster of the users that marked ‘attended’ for the activity. The provider will confirm that each user attended the activity by clicking another check box, next to the user's name labeled, ‘confirm’. The user will see that the provider has verified the user's attendance at the activity. If the course does not require postwork, the provider will give the continuing education credits for the activity to the user. The credits will display in the user's interface and in the user's transcript and in the provider's roster of users that completed the activity and received credits for the activity. Additionally, a certificate of completion will be generated for physicians to print, if necessary. If the activity requires post-work, the provider will assign the post-work, through the system after the activity. Users can upload post-work to the system for review by the provider. After the provider approves the course work, the user will receive credit for the activity. The credits will appear in the user's interface, transcripts, and in the provider's roster of users that completed the activity and received credits for the activity. Providers can upload activity evaluations to system for users to complete. Users can complete the evaluations through the system and providers will be able to access them.

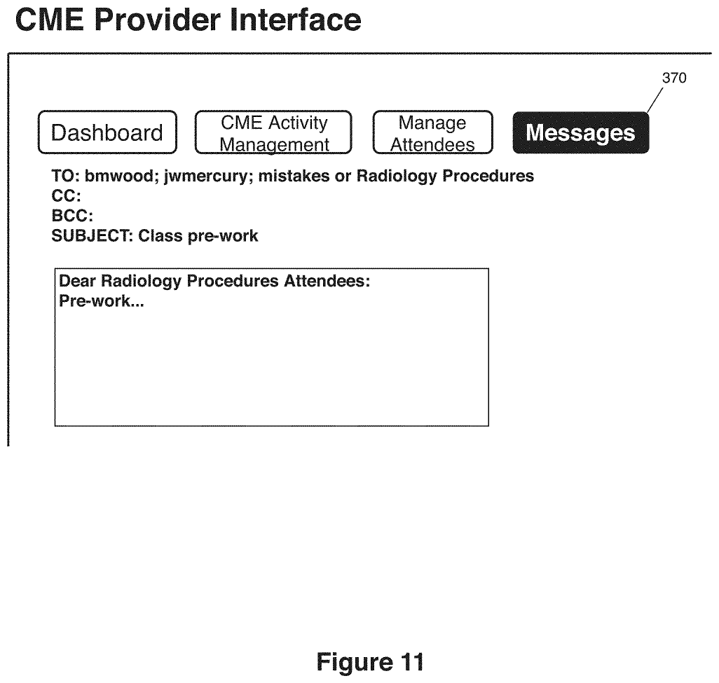

As illustrated in FIG. 11, the provider messages 370 component allows a provider to access and read existing messages, and compose and send new messages to participants. Providers will also have the ability to attach documents to the emails. Providers will have data dashboards available. The dashboard will detail, CME activities offered by the provider, number of users that attended the activity, number of users that registered for the activity, number of users waitlisted for the activity, and the composition of the years—Radiologists, Internists, Dermatologists, NICU Nurses, ICU Nurses, etc. At year end, all providers will receive an aggregate report from CME Suite that outlines the most attended activities, the topic of the activities, the focus, and the clinician specialties.

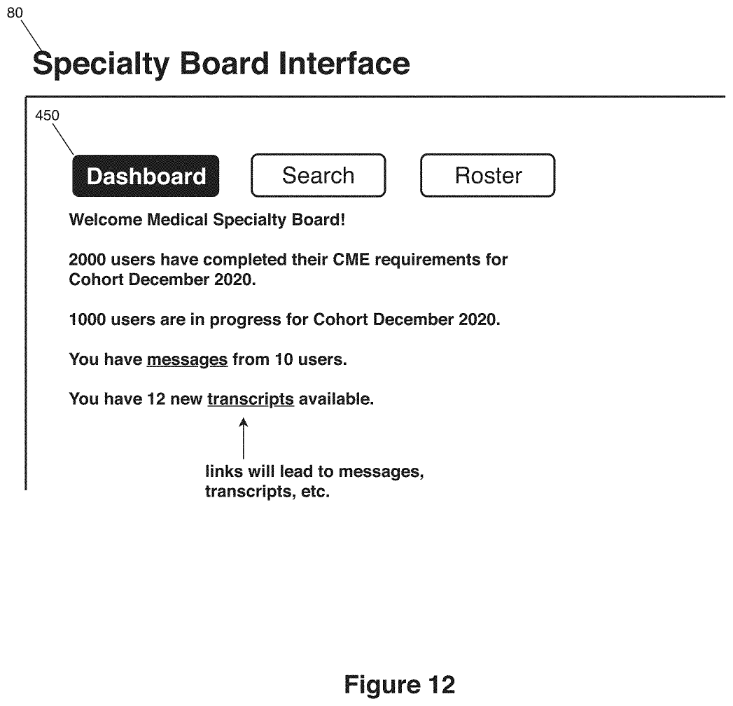

In the example embodiment illustrated in FIG. 12, a continuing education management interface for reviewers 80 provides the following components: dashboard 450, search 550, and roster 650. The reviewer dashboard 450 component includes a welcome message, statistics, and messages.

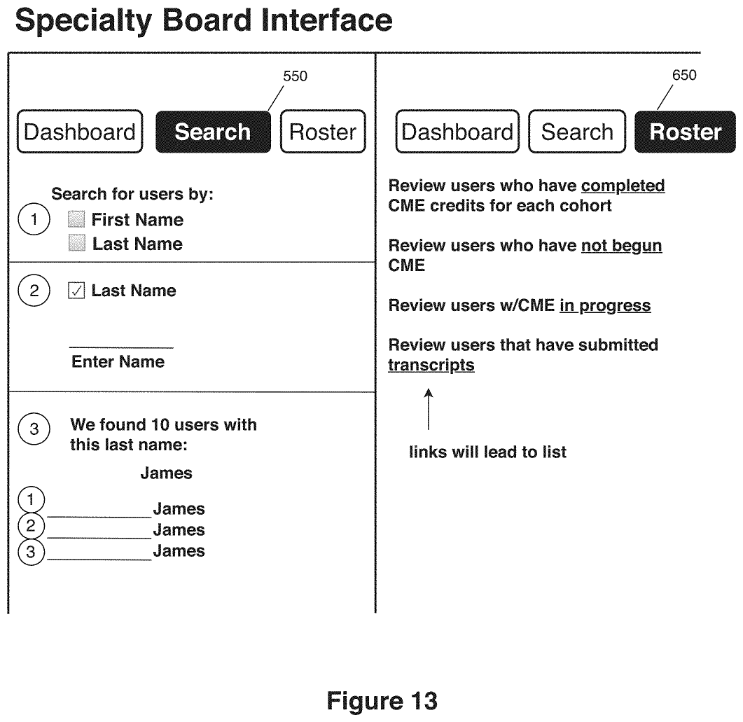

The search 550 component illustrated in FIG. 13 enables a reviewer to search for a user by first name or last name.

The roster 650 component enables a reviewer to review users who have completed their continuing education courses for each cohort, users who have not, users who have a few continuing education credits done, and to see user's transcripts.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims. Other embodiments may be utilized, and other changes may be made, without departing from the spirit or scope of the subject matter presented herein. It will be readily understood that the aspects of the present disclosure, as generally described herein and illustrated in the figures, can be arranged, substituted, combined, separated, and designed in a wide variety of different configurations, all of which are contemplated herein.

What is claimed is:

1. A system for managing continuing education comprising:
a processor;
a client unit;
a server unit;
a computer readable storage medium that comprises instructions stored in the computer readable storage medium that are executable with the processor, the instructions comprising:
instructions to receive user search input;
instructions to transmit an activities list from the server unit to the client unit based on received user search input;
instructions to transmit a selected activity from the client unit to the server unit;
instructions to transmit an enrollment confirmation message from the server unit to the client unit;
instructions to transmit information activity details from the server unit to the client unit at a specified time interval;
instructions to display activity details on the client unit;
instructions to transmit activity attendance details from the client unit to the server unit upon receiving activity attendance details from a user;
instructions to store and update user-associated activity credit details on the server unit upon receipt of activity attendance details from the client unit.
